(19) United States
(12) Patent Application Publication
(10) Pub. No.: US 2011/0076367 A1
(43) Pub. Date: Mar. 31, 2011

(54) FOOD CASING HAVING AN ADHESIVE SYSTEM AND A TRANSFERABLE FUNCTIONAL SUBSTANCE

(75) Inventors: Christian Auf der Heide, Osnabruck (DE); Anton Krallmann, Bad Fallingbostel (DE); Heinrich Henze-Wethkamp, Walsrode (DE)

(73) Assignee: CASETECH GMBH, Bomlitz (DE)

(21) Appl. No.: 12/893,333

(22) Filed: Sep. 29, 2010

(30) Foreign Application Priority Data
Sep. 29, 2009 (EP) 09 012 355.5

(51) Int. Cl. A22C 13/00; A23L 1/317

(52) U.S. Cl. 426/135; 426/517; 426/574

(57) ABSTRACT

The invention relates to a single layer or multilayer tubular food casing, in particular for foods which are scalded, cooked or heated in other ways in the casing, preferably for cooked-meat or scalded-emulsion sausages, hams, cured products or processed cheese, wherein the invention only relates to those casings which have an internal layer which consists of a thermoplastic polymer or predominantly comprises one such, having a substantially smooth, non-absorbent, non-porous and non-felt-like and non-woven-fabric-like surface.

### CROSS-REFERENCE TO RELATED APPLICATIONS

This application claims the benefit of European Patent Application Number 09 012 355.5 filed on Sep. 29, 2009, the disclosure of which is hereby expressly incorporated by reference in its entirety and hereby expressly made a portion of this application.

### BACKGROUND

1. Field of the Invention

The invention relates to a single layer or multilayer tubular food casing, in particular for foods which are scalded, cooked or heated in other ways in the casing, preferably for cooked-meat or scalded-emulsion sausages, hams, cured products or processed cheese, wherein the invention only relates to those casings which have an internal layer which consists of a thermoplastic polymer or predominantly comprises one such, having a substantially smooth, non-absorbent, non-porous and non-felt-like and non-woven-fabric-like surface.

2. Description of the Related Art

In the case of the said foods, a color and/or aroma transfer from the casing to the food is increasingly desired during the cooking or scalding process. Scalded-emulsion sausage and cooked cured products are still produced to a greater extent in cellulose fiber skin. This cellulose fiber skin has a high water vapor permeability and gas permeability in order to smoke the products during the production process. It is further known that cellulose fiber skins are impregnated with liquid smoke in order to shorten the smoking time. However, the production of foods in cellulose fiber skin, owing to the water vapor permeability and gas permeability of the casing, is always associated with loss of weight, flavor and aroma during the production process, during cooling and during storage. In order to avoid the disadvantage of water vapor permeability and gas permeability, plastic casings have been specially developed for large-scale industry from materials which are impermeable to water vapor and gas. When such plastic casings are used, neither during the production process, nor during storage and distribution, is there a loss in weight, aroma and flavor. Impregnating pure plastic casings with functional substances such as aroma substances, spices and similar substances, however, does not first lead to success, since the plastics used cannot absorb functional substances sufficiently, and so during finishing and during the filling of the plastic casings, these functional substances are stripped off again.

EP 0992194 solves this problem in that the casing carries an absorbent inner layer that is bonded thereto and is made of individual fibers or a woven fabric, loop-formingly knitted fabric, loop-drawingly knitted fabric or nonwoven, and in that this inner layer is impregnated with dyes and/or aroma substances.

U.S. Pat. No. 3,330,669, in contrast, describes the use of thickened smoking liquid. The smoking liquid is, however, sprayed onto the inner surface of a cellulose casing, which has, however, the above-described disadvantages such as water vapor permeability and gas permeability. The uniform layer applied should stick to the surface and remain adhering thereto. It is only possible to generate this layer by spraying the thick smoking liquid onto the sausage casing immediately before filling with the chopped meat emulsion or before filling with this solution and subsequent draining of the surplus and drying. Application of the smoking liquid to such casings, furthermore, frequently leads to only an inadequate amount of the liquid remaining adhering on the surface, and it is distributed extremely unevenly on the surface.

A technical solution is found in US 2004/0197583. There, a film is described in which a smoking liquid containing a viscosity modifying agent and a surface-active substance is applied to the inner surface. The liquid smoke composition is there absorbed on the inner surface of the film at least in part into the pores. The pores are formed after a corona, plasma, radiation or chemical treatment.

The sausage casing according to DE-A 195 00 470, on the inside, has an adhesive layer solidifying from the liquid state, wherein as casing material, cotton woven fabric having a linen weave is disclosed. Before the solidification, spice particles, in particular peppercorns or ground pepper, are applied thereto. This is achieved preferably by being spun on using special devices.

EP-B 0 408 164 describes a matrix material of natural or synthetic fibers which is resistant to water and heat. On this matrix material, a layer of herbs, spices, seafood or milk products in powder or chip form is applied. The bond between the layer of the food and the matrix material is achieved by an adhesive layer of an edible water-soluble high-molecular-weight material which is suitable as a food supplement. This adhesive layer comprises natural polysaccharides, sodium carboxymethylcellulose, carboxymethyl starch or the like.

EP 1820404 B1 describes a food casing having a support based on at least one water-insoluble thermoplastic polymer, a polymer of animal or plant origin, or regenerated or precipitated cellulose which has internally a coating which contains a binder and at least one additive which is transferable to the filling, wherein the additive consists of fine- to coarse-grained foods or mixtures having a median particle size of at least 60 μm. However, in the examples, only cellulose casings or other absorbent or adsorptive casings are described, or flat films which are wrapped around a dimensionally stable food. Tubular casings having an internally substantially smooth, non-absorbent, non-porous and non-felt-like and non-woven-fabric-like surface made of a thermoplastic polymer are not described.

### SUMMARY

It was then an object of the present invention to provide a food casing, in particular for sausages, which is tubular, preferably seamless, which internally, has a substantially smooth, non-absorbent, non-porous and non-felt-like and non-woven-fabric-like surface, wherein the internal surface consists of a thermoplastic polymer or predominantly comprises one such, and with which a functional substance such as, for instance aroma, spice and/or a dye can be transferred very efficiently, uniformly and readily meterable, to the food that is stuffed into the casing. In addition, it was an object to provide a corresponding method for producing such a food casing.

This object is achieved by a single layer or multilayer tubular food casing comprising an internal layer which consists of a thermoplastic polymer or predominantly comprises one such, having an internally substantially smooth, non-absorbent, non-porous and non-felt-like and non-woven-fabric-like surface, characterized in that a composition is applied to the internal surface, wherein the composition comprises at least one binder suitable for foods and at least one functional substance that is transferable to the food.

### DETAILED DESCRIPTION OF THE EMBODIMENTS

As described at the outset, in the case of pure plastic casings which frequently have a smooth and non-absorbent inner surface, the treatment with one or more functional substances leads to the fact that during finishing and during the filling of the plastic casings, these functional substances are stripped off again. In the case of plastic casings, if appropriate also in the case of plastic casings made of the thermoplastic polymers which are the subject here, which have a rough, relief-like, porous, felt-like inner surface, and/or are otherwise like an absorbent inner surface, this problem does not exist, or not to such a great extent. The present solution according to the invention of the problem described therefore explicitly relates to casings having an internal surface which do not have the described rough, relief-like, porous, felt-like properties and/or otherwise like absorbent properties, that is to say to casings having an “internally substantially smooth, non-absorbent, non-porous and non-felt-like and non-woven-fabric-like surface”.

The solution according to the invention now envisages that a composition is applied to such an inner surface, which composition, in addition to the functional substance(s) which are to be transferred to the food, contains at least one binder. The binder or binders must be edible, that is to say suitable for food use, since the food which is removed from the casing before consumption can have absorbed at least some of the binder, or all thereof. “Composition” here is taken to mean a mixture consisting of a plurality of different components, or containing such components. This mixture can be moist in the applied state, dry or anhydrous, pasty or else viscous. The composition/mixture, can alternatively be dried, that is to say it can be applied in the moist, pasty or low-viscosity state or in the form of a slurry, emulsion, solution or the like, and have subsequently been dried. Thoroughly polymerized compositions or polymerizing and therefore polymer film-forming compositions are not meant here.

With respect to the scope of the application, it is preferred that the composition is applied to the internal surface substantially over the whole surface. “Substantially over the whole surface” is taken to mean that, apart from possibly in the end region of the casing, preferably 100%, at all events at least 95%, of the inner surface is coated with the composition. The application, however, can also be performed only partially, that is to say e.g. on a half side, or certain regions of the surface can be coated with a pattern, e.g. what are termed “grill marks”, in this manner.

It was surprising that, using the casings finished according to the invention, casings are also suitable for transferring functional substances to foods, which casings are usually unsuitable therefor. Thus, other sectors in the food range that were not previously accessible to such a functional transfer can be opened up.

Suitable binders are, in particular, polysaccharides such as cellulose derivatives, especially ethers or esters of cellulose, such as methylcellulose or sodium carboxymethylcellulose, in addition also alginic acid and/or alginate, chitosan, pectin, carrageenan or starch, or starch derivatives, proteins, such as gelatin and gelatin hydrolyzates, collagen, albumin, casein, zein, wheat protein, soy protein or pea protein, preferably blood hydrolyzate, blood plasma, myoglobin, protein hydrolyzates having molecular weights from 5000 to 30 000 dalton, acid-boiled collagen having molecular weights from 20 000 to 1 000 000 dalton or desamido collagen which is obtainable by alkaline hydrolysis. Suitable binders are, in addition, fats, waxes, oils or other hydrophobic water-insoluble substances which soften or become liquid under the action of heat, losing their adhesive force and thus effecting transfer of the functional substance. These can be tallows, drying oils, non-drying oils, semi-drying oils, waxes, fatty acids, esters of fatty acids, fatty alcohols or mixtures thereof. These hydrophobic substances can be mixed with the abovementioned proteins, in particular with heat-coagulable proteins. Lipids have the additional advantage that they—provided that they are co-transferred—act as flavor enhancers for spices or other additives.

Preferred binders are polysaccharides, for example ethers or esters of cellulose, sodium carboxymethylcellulose (CMC) being particularly preferred. The polysaccharide or the composition containing the polysaccharide can be applied as aqueous solution or aqueous slurry to the internal surface of the casings and be subsequently dried. That means that in this case the internally applied binder of the casing according to the invention is based on an aqueous solution or slurry of such a polysaccharide.

Carboxymethylcellulose is particularly suitable as binder in the context of the present invention because it may readily be brought into solution, not only in cold water but also in hot water. Therefore CMC may be easily used under different production conditions and for different purposes of use. A disadvantage with, e.g., methylcellulose (MC) is that it is not so readily soluble, in particular not in hot water at >55° C. For the subsequent application of the composition containing the binder, it is advantageous if the binder is dissolved and not only slurried.

A further variant is to dissolve the binder, not in water, but in another substance, e.g. directly in the functional substance (e.g. liquid smoke).

A further advantage of CMC-based compositions is that the (dried) coating is more transparent than is the case with, e.g., MC-based coatings, but also better than in the case of many other binders.

The cold-water and hot-water solubility of CMC also has the advantage that the casing may be easily removed again from the finished encased food before consumption of the food, since the generally moist food has already partially dissolved or dissolved the coating composition.

Finally, CMC is also less expensive than MC and many of the other said binders. All the more surprising, that many advantages result precisely from the use of CMC as binder.

The thermoplastic polymer of which the internal layer consists exclusively or substantially is preferably selected from the group consisting of polyamides; polyvinylidene chlorides (PVDC); polyvinyl chlorides (PVC); polystyrenes; polyesters; polyacrylates; polyolefins, such as polyethylene; or copolymers based on said polymers.

“Internal layer which consists of a thermoplastic polymer or predominantly comprises one such” is here taken to mean quite generally all internal layers which comprise more than 50% by weight of a thermoplastic polymer. That is to say, e.g., layers which comprise up to 100% of a thermoplastic polymer or a blend of different thermoplastic polymers, but also layers which contain less than 50% by weight of other components such as fillers or additives. Fillers can be, e.g., silicon dioxide, talcum (Mg₂SiO₄), aluminum oxide, aluminum hydroxide, hydrated alumina, calcined alumina, titanium dioxide, zirconium oxide, sodium silicate and/or silicate. Additives can be lubricants, antiblocking agents, nucleating agents, fillers, color pigments and/or other additives.

For further delimitation of the casings according to the invention from the prior art and in a preferred embodiment, the feature of an “internally substantially smooth, non-absorbent, non-porous and non-felt-like and non-woven-fabric-like surface” of the surface corresponds to an internal layer which consists of a material that has a water absorption capacity of less than or equal to 5%, preferably less than or equal to 2%, particularly preferably less than 1.5%, measured as specified in ASTM D 570 (24 h) and a surface gloss of more than 2, preferably more than 5, particularly preferably more than 10 gloss units, to DIN 67539/ISO 2813 at an angle of measurement of 85 degrees.

On the water absorption capacity of the material of the internal layer including the internal surface, it must be said that this is a useful measure of the absorption capacity and porosity of the internal surface of the casings according to the invention and is readily suitable for delimitation from casings of the prior art. For instance, the water absorption capacity as specified in ASTM D 570 (24 h) of cellulose fiber is 9%, cellulose acetate 6%, nylon 6 1.9%, nylon 66 1.5%, PVC 0.5%, PET 0.3%, PP 0.03% and PE <0.01%.

On the criterion specular gloss, it may be said that this is a useful measure of the smoothness or roughness of the internal surface of the casings according to the invention and is readily suitable for delimitation from casings of the prior art. The smaller the gloss values are, the more the surface appears matt and therefore the rougher is the surface. Thus, using the gloss meter Micro-Tri-Gloss/from BYK Gardner GmbH as specified in DIN67530 (ISO 2813) the specular gloss was measured by way of example on unprinted casings: polyamide casing (K flex/from CaseTech GmbH) 83, matted polyamide casing (K flex matt/CaseTech) 39, externally PVDC-coated cellulose fiber skin (FVP/CaseTech) 25, cellulose fiber skin (FR/CaseTech) 10, cellulose fiber skin matt (FMT/CaseTech) 5, textile skin (Betex RS and Betex KD natural/from Texda) 1, and as a comparison cellulose fiber nonwoven (25 g/m², Ahlstrom) 2, cellulose hand towel (hand towel white/Profix) 0.5.

The composition, in addition to the main binder carboxymethylcellulose, can contain one or more further binders, e.g. selected from the group consisting of other cellulose ethers, such as methylcellulose; starch or starch derivatives; casein; wheat protein; soy protein; albumin; gelatin; collagen; alginate; carrageenan; glucomannan; and also combinations thereof.

The “functional substance”, in the context of this invention, is an aroma, a dye, a spice or another food additive, provided that the substance can be used in fresh meat and fish processing or sausage and cheese production. These include all spices, vegetables, herbs, fungi, cereals and nuts and also cheese types in any desired form (e.g. grated, in flakes, in pieces or molten etc.). These also include aroma and/or flavor substances such as pepper, coriander, curry, chilli, paprika, cinnamon, caramel, garlic, onions, leek, carrots, paprika and capsicum pods, celery, asparagus and other vegetables in any possible form, fruits, but also fresh or dried, rubbed herbs, e.g. parsley or dill, in particular dill tips, in short, everything which can make meat, sausage, fish or cheese products tastier or refines them. In addition to the abovementioned substances, the expression “functional substance” also include food additives, in particular coloring agents, and especially liquid smoke. Those which may be mentioned as preferred are: caramel, food dyes E124 (cochineal red A), E155 (brown HT), E120 (carmine), paprika oleo resin (E160C), concentrates and extracts of elderberry, plums or tomatoes, cereals (in particular barley) and preparations thereof (such as malt or malt extract), carob bean meal, guar gum meal, coffee, chicory or cocoa etc.

For clarification, it may be stated that the “functional substances” described here differ from the “foods” and “foodstuffs” mentioned here, even if the functional substances can be foods or foodstuffs in the conventional sense. “Foods” and “foodstuffs” in the context of the present invention are those fillings which are to be enclosed by the casing according to the invention.

The food casing according to the invention can be with a seam or seamless. In the case of seamless casings there can be a difficulty with applying a composition, a solution, a paste or a viscous mass on the inside of the casing in such a manner that a full-surface coating is achieved. In the case of tubular casings having a seam this problem can be bypassed by coating a lying flat film and only then shaping it to form a tubular film and providing it with a seam. An advantage of the casings according to the invention is then that, by means of the process described hereinbelow and using the composition described here, these casings can be provided in the seamless state, since the composition, owing to the binder, adheres so well to the casing surface that the casing can be coated “inside out” and not used until afterward. In the case of a seamless food casing according to the invention, it can uniaxially or biaxially optionally be stretched.

In a particular embodiment of the invention, the food casing can have a shrinkage property such that the casing shrinks under the influence of heat, and optionally moisture, or during drying of the wet casing.

A typical and preferred food casing according to the invention appears such that the composition consists of 3 to 99% by weight of binder(s), 97 to 1% by weight of functional substance(s) and 0 to 30% by weight of other components (including water or residual water after an optional drying step). More preferably, the composition comprises 15 to 80% by weight of binder(s), 85 to 20% by weight of functional substance(s) and 0 to 25% by weight of other components. Still more preferably, the composition comprises 40 to 70% by weight of binder(s), 60 to 30% by weight of functional substance(s) and 0 to 25% by weight of other components.

The composition applied can, in addition to said binders and functional substances, further comprise “other components”. For instance, for increasing the elasticity, the wettability and the microbiological stability, it can be expedient to combine the binder with at least one appropriate component. Components suitable for this purpose are, e.g., lactic acid and salts thereof, for example sodium lactate, glycerol, emulsifiers such as lecithin and/or fats and oils. They ensure particularly uniform and continuous application of the binder. The fraction of the components of the coating or impregnating liquid is expediently 0.5 to 15.0% by weight, preferably 2.0 to 8.0% by weight. “Other components” also includes water or residual water after an optional drying step.

Typically, the functional substance(s) is/are mixed into the composition, i.e. the composition, has been produced mixed with all components including the functional substance(s) before the composition is applied to the internal surface. In one variant of the food casing according to the invention, the functional substance(s) can also be applied at least in part subsequently to the previously applied composition, wherein, optionally, the remaining fraction of the functional substance(s) is mixed into the composition. The subsequent application of the functional substance(s) can proceed after or before drying or allowing the composition that is already applied to dry. In the case of subsequent application of the functional substance(s), these, depending on their type and the circumstances, can be applied in pure form or as a formulation with other components or as a dilute solution.

The present invention also relates to a casing according to the invention that is filled with a corresponding food.

The above-described internally coated food casings by means of which at least one functional substance can be transferred to the food that was subsequently stuffed into the casings can be produced according to the invention by a process which comprises the following steps:

a) preparing a single layer or multilayer tubular food casing comprising an internal layer made of a thermoplastic polymer having an internally substantially smooth, non-absorbent, non-porous and non-felt- and non-woven-fabric-like surface, wherein the internal surface is first positioned on the outside during preparation,

b) applying a composition to the outside surface of the internal layer of the food casing, wherein the composition comprises at least one binder suitable for foods and at least one functional substance that is transferable to the food, wherein
i) the functional substance(s) is (are) mixed into the composition before the application, or wherein
ii) the functional substance(s) is (are) applied at least in part subsequently to the previously applied composition,

c) optionally drying the applied coating(s) or allowing the applied coating(s) to dry, and in any case

d) turning the coated casing, so that the coating(s) come(s) to lie on the inside.

As already described above, the composition can be applied to the internal surface substantially over the whole surface, or only in part. “Substantially over the whole surface” means that, apart from possibly in the end region of the casing, preferably 100%, in any case at least 95%, of the internal surface is coated with the composition.

In the above-described steps b)i) and/or b)ii), the composition or the functional substance(s) can be applied by spraying, printing, knife application, painting, flocking or calendering. Processes are described in the literature (for example A. Giessmann/2003 “Substrat-und Textilbeschichtung” [Substrate and Textile Coating]). Optionally, a different application process can be used for the functional substance from that for the composition. In the case of a plurality of functional substances, different application processes can also be used for these, depending on the type of the functional substances.

The composition can be applied in a single stage or multiple stages. In the case of a multistage process, first a first part of the composition is applied. Before the optionally final drying, a second part and then optionally a further part of the composition is applied.

As mentioned, the present invention also relates to a casing according to the invention stuffed with an appropriate food, in particular in which a corresponding functional transfer to the stuffed food takes place or has taken place. Therefore, the present invention further relates to a method for transferring at least one functional substance to a food, in particular to sausage emulsion, which method comprises the steps:

a) producing an internally coated food casing by the method described above,

b) stuffing the food, in particular sausage emulsion, into the casing thus produced, and

c) transferring the functional substance(s) to the food, in particular to the sausage emulsion.

The transfer of the functional substance(s) can proceed at room temperature, therebelow or thereabove. Below room temperature the transfer proceeds preferably by intimate contact of the filling with the food casing. This transfer can take place even at temperatures below 15° C., preferably below 10° C., and in particular below 7° C. Generally, the transfer time is less than 50 hours, preferably less than 20 hours, in particular less than 10 hours. The transfer time depends on individual cases and can be determined by simple preliminary experiments. Suitable binders which are (also) suitable for transfer at room temperature or therebelow are, for example, alkaline milk protein, protein hydrolyzate, methylcellulose and carboxymethylcellulose, since these detach from the casing without the action of heat and bind to the filling. For transfer of the functional substance(s) at temperatures at least above 55° C., of the celluloses, owing to its solubility properties, in particular carboxymethylcellulose is more suitable than, e.g., methylcellulose, which is insoluble at these high temperatures.

Transfer of the functional substance(s) during scalding, cooking or other heating operations obviously proceeds at temperatures above room temperature. In this case, owing to the action of heat, the adhesion or binding of the functional substance(s) to the binder is decreased and the functional substance(s) can be released. Temperatures from 30 to about 90° C. are sufficient for activating the binder.

In all temperature cases, the transfer operation can be accelerated or intensified if at least one layer of the casing has a shrinkage property which, for example, is such that the casing either shrinks under the influence of moisture or under the influence of heat at least in the range between 70 and 90° C.

In addition, the present invention relates to the use of a food casing as described above for transferring at least one functional substance to a food, in particular to sausage emulsion.

The transfer can take place under the action of heat, at room temperature or also therebelow. Thus, the casing according to the invention can be used, for example, in the production of cooked-meat and scalded-emulsion sausage, but also for enhancing ham, cured products and even cheese, e.g. processed cheese. Secondly, the casing is also suitable for transferring transferable functional substance(s) to filling which must be treated particularly gently, and to sensitive filling which must be processed or stored chilled. Examples thereof are fish, fresh meat, and also cooked ham, scalded-emulsion sausage and cooked-meat sausage, and also raw sausage.

The use of a composition comprising at least one binder suitable, for foods and at least one functional substance for transferring the functional substance(s) to a food, in particular to sausage emulsion, is likewise subject matter of the present invention.

### EXAMPLES

### Example 1

A coextruded biaxially stretched plastic flexible tube (Walsroder K flex Kal. 105 type/CaseTech GmbH) having a polyamide layer on the inside and on the outside was coated on the complete surface on the outside, thus on both sides, the flat state with a blend of 50% by weight 10% strength aqueous CMC solution and 50% by weight liquid smoke using a roller spreader application. The resultant approximately 40 μm thick film (moist weight 40 g/m²) on the polyamide casing was then dried by circulated air drying at 90° C. (20 g/m²). The coated polyamide casing was turned and stuffed with sausage emulsion and scalded at 76° C. for approximately 1 hour. After a cooling time of approximately two hours, the polyamide casing was removed from the resultant sausage. A very uniformly transferred smoke rim on the sausage was exhibited.

### Example 2

A cellulose fiber skin externally coated with PVDC (Walsroder FVP type/CaseTech GmbH) was coated on the complete surface with a blend of 50% by weight 10% strength aqueous CMC solution, 48% by weight liquid smoke and 2% by weight glycerol by an air-knife method. In this case the casing was immersed in the mixture and then part of the mixture was stripped off from the surface using compressed air. The resultant approximately 40 μm thick film (moist weight 40 g/m²) on the casing was then dried (20 g/m²) by circulated air drying at 90° C. The coated casing was turned and stuffed with sausage emulsion and scalded at 76° C. for approximately 1 hour. After a cooling time of approximately two hours, the polyamide casing was removed from the resultant sausage. A very uniformly transferred smoke rim was found on the sausage.

### Example 3

As in Example 1, a flexible polyamide tube was produced and was coated on one side in the flat state with a blend of 50% by weight 10% strength aqueous CMC solution, 48% by weight liquid smoke and 1% by weight Tween 80 by a roller spreader application. The resultant approximately 40 μm thick film (moist weight 40 g/m²) on the casing was then dried (20 g/m²) by circulated air drying at 90° C. The coated casing was turned and stuffed with sausage emulsion and scalded at 76° C. for approximately 1 hour. After a cooling time of approximately two hours, the polyamide casing was removed from the resultant sausage. A very uniformly transferred smoke rim was found on the half perimeter of the sausage.

### Example 4

As in Example 1, a polyamide casing was fabricated and was sprayed on the complete surface with a blend of 50% by weight 10% strength aqueous CMC solution, 30% by weight liquid smoke and 20% by weight carnauba wax by nozzle application. The resultant approximately 60 μm thick film (moist weight 60 g/m²) on the polyamide casing was then dried (30 g/m²) by circulated air drying at 90° C. The coated polyamide casing was turned and stuffed with sausage emulsion and scalded at 76° C. for approximately 1 hour. After a cooling time of approximately two hours, the polyamide casing was removed from the resultant sausage. A very uniformly transferred smoke rim was found on the sausage.

### Example 5

As in Example 1, a polyamide casing was fabricated and was coated on the complete surface with a blend of 50% by weight 10% strength aqueous CMC solution, 40% by weight liquid smoke and 10% by weight of grilling aroma by roller application on both sides. The resultant approximately 60 μm thick film (moist weight 60 g/m²) on the polyamide casing was then dried (30 g/m²) by circulated air drying at 90° C. The coated polyamide casing was turned and stuffed with sausage emulsion and scalded at 76° C. for approximately 1 hour. After a cooling time of approximately two hours, the polyamide casing was removed from the resultant sausage. A very uniformly transferred smoke rim was found on the sausage.

### Examples 6-10

As described in the table, said casings were coated with approximately 40 μm of a 10% strength aqueous CMC solution using said application processes. After the coating, in each case fine-grained spices (curry and paprika) were applied (by tossing or shaking) and then the samples were further processed as described above. The corresponding sausages had surfaces with spice on the complete surface or in segments. The casings could be detached from the sausage emulsion and the spice completely and without residue.

### Example 11

As in Example 1, a polyamide casing was fabricated and coated, not on the complete surface, with a blend of 50% by weight 10% strength aqueous CMC solution, 40% by weight liquid smoke and 10% by weight of grilling aroma by double-sided roller application. Similarly to the pressure method, approximately 5 mm wide lines inclined at an angle of 45° to the longitudinal line were applied at a distance of 4 cm. The resultant approximately 60 μm thick lines (moist weight 4 g/m²) on the polyamide casing were then dried (0.8 g/m²) by circulated air drying at 90° C. The polyamide casing coated with liquid smoke and grilling aroma was turned and stuffed with sausage emulsion and scalded at 76° C. for approximately 1 hour. After a cooling time of approximately 2 hours, the polyamide casing was removed from the resultant sausage. Completely coated dark smoking lines (grilling marks) were found on the sausage, which could otherwise customarily only be generated by grilling sausage, meat and fish products.

### Example 12: (Comparative Example)

As in Example 1, a polyamide casing was fabricated and was coated on the complete surface with a liquid smoke (liquid smoke 1) by roller-spreader application. The liquid smoke film on the polyamide casing was then dried by circulated air drying at 90° C. for approximately 1 minute. The liquid-smoke-coated polyamide casing was turned and stuffed with sausage emulsion and scalded at 76° C. for approximately 1 hour. After a cooling time of approximately 2 hours, the polyamide casing was removed from the resultant sausage. A very unevenly transferred smoked rim was found on the sausage. On turning of the casing, problems occurred, especially severe erosion of the liquid smoke.

### Overview of Examples 1-19

TABLE 1

| | | | | | | Result of |
|---|---|---|---|---|---|---|
| | | | | | Result of transfer of | transfer, smoked |
| Example | Casing | Coating | Formula of the coating | Gloss | taste or odor from | color or |
| No. | as per | application as per | (on application) | units | smoke or seasoning | seasoning |
| 1 | Example 1 | Example 1 | 50% by weight CMC | 83 GU | Good | Very good |
| | | | 50% by weight liquid smoke 1 | | | |
| 2 | Example 2 | Example 2 | 50% by weight CMC | 25 GU | Good | Very good |
| | | | 48% by weight liquid smoke 1 | | | |
| | | | 2% by weight glycerol | | | |
| 3 | Example 1 | Example 3 | 50% by weight CMC | 83 GU | Good | Very good |
| | | | 49% by weight liquid smoke 2 | | | |
| | | | 1% by weight Tween 80 | | | |
| 4 | Example 1 | Example 4 | 50% by weight CMC | 83 GU | Good | Very good |
| | | | 30% by weight liquid smoke 1 | | | |
| | | | 20% by weight carnauba wax | | | |
| 5 | Example 1 | Example 5 | 50% by weight CMC | 83 GU | Good | Very good |
| | | | 40% by weight liquid smoke 3 | | | |
| | | | 10% by weight grill aroma 1 | | | |
| 6 | Example 1 | Example 1 | 1. 100% by weight CMC | 83 GU | Good | Very good |
| | | | 2. then curry powder | | | |
| 7 | Example 2 | Example 2 | 1. 100% by weight CMC | 25 GU | Good | Very good |
| | | | 2. then curry powder | | | |
| 8 | Example 1 | Example 3 | 1. 100% by weight CMC | 83 GU | Good | Very good |
| | | | 2. then curry powder | | | |
| 9 | Example 1 | Example 4 | 1. 100% by weight CMC | 83 GU | Good | Very good |
| | | | 2. then curry powder | | | |
| 10 | Example 1 | Example 5 | 1. 100% by weight CMC | 83 GU | Good | Very good |
| | | | 2. then curry powder | | | |
| 11 | Example 1 | Example 11 | 50% by weight CMC | 83 GU | Grilling mark good, | Grilling mark |
| | | | 40% by weight liquid smoke 3 | | slight grill aroma | readily visible |
| | | | 10% by weight grill aroma 1 | | | |
| 12 (com- | Example 1 | Example 12 | Liquid smoke 1 | 83 GU | Adequate | Adequate, stripy |
| parison) | | | | | | |

| | | |
|---|---|---|
| CMC (10% strength aqueius solution) | Dow Wolff Cellulosics | Walocel CRT 30 GA |
| Liquid smoke 1: | Red Arrow | SmokeEz MB 45 GF |
| Liquid smoke 2: | Red Arrow | SmokeEz Supreme C |
| Liquid smoke 3: | Red Arrow | RA 04006 |
| Grill aroma 1: | Red Arrow | Roastin 3123 |
| Tween 80 | ICI Surfactants | Tween 80 |
| Carnauba wax | Michelman | ML 160 PF/E |
| Curry powder | Alba | Indian Style |

What is claimed is:

1. Single layer or multilayer tubular food casing stuffed or not stuffed with an appropriate food, which food casing comprises an internal layer which consists of a thermoplastic polymer or predominantly comprises one such, having an internally substantially smooth, non-absorbent, non-porous and non-felt-like and non-woven-fabric-like surface, wherein a composition is applied to the internal surface, the composition comprising at least one binder suitable for foods and at least one functional substance that is transferable to the food.

2. Food casing according to claim 1, wherein the composition is applied to the internal surface substantially over the whole surface or in part.

3. Food casing according to claim 1, wherein the binder is a polysaccharide, preferably an ether or ester of cellulose, particularly preferably carboxymethylcellulose, or is based on an aqueous solution of such a polysaccharide.

4. Food casing according to claim 1, wherein the thermoplastic polymer of the internal layer is selected from the group consisting of polyamides; polyvinylidene chlorides (PVDC); polyvinyl chlorides (PVC); polystyrenes; polyesters; polyacrylates; polyolefins, such as polyethylene; or copolymers based on said polymers.

5. Food casing according to claim 1, wherein the material of the internal surface has a water absorption capacity of less than or equal to 5% measured as specified in ASTM D 570 (24 h) and a surface gloss of more than 2 gloss units to DIN 67539/ISO 2813 at an angle of measurement of 85 degrees.

6. Food casing according to claim 1, wherein the functional substance is an aroma, a dye, a spice or another food additive.

7. Food casing according to claim 1, wherein the casing is seamless and is optionally uniaxially or biaxially stretched.

8. Food casing according to claim 1, wherein the casing has a shrinkage property such that the casing shrinks under the influence of heat, and optionally moisture, or during drying of the wet casing.

9. Food casing according to claim 1, wherein the composition consists of 3 to 99% by weight of binder(s), 97 to 1% by weight of functional substance(s) and 0 to 30% by weight of other components.

10. Food casing according claim 1, wherein the functional substance(s) can be mixed into the composition or at least in part subsequently applied to the previously applied composition.

11. A method of transferring at least one functional substance to a food comprising:
providing said at least one functional substance to a composition that is applied to a single layer or multilayer tubular food casing,
wherein said single layer or multilayer tubular food casing is stuffed or not stuffed with an appropriate food, which food casing comprises an internal layer which consists of a thermoplastic polymer or predominantly comprises one such, having an internally substantially smooth, non-absorbent, non-porous and non-felt-like and non-woven-fabric-like surface, wherein the composition is applied to an internal surface, the composition comprising at least one binder suitable for foods.

12. The method according to claim 11, wherein the food is sausage emulsion.

13. A method of making the food casing according to claim 1 comprising:
applying a composition to an internal surface of a single layer or multilayer tubular food casing stuffed or not stuffed with an appropriate food, which food casing comprises an internal layer which consists of a thermoplastic polymer or predominantly comprises one such, having an internally substantially smooth, non-absorbent, non-porous and non-felt-like and non-woven-fabric-like surface, wherein the composition comprises at least one binder suitable for foods and at least one functional substance that is transferable to the food.

14. The method according to claim 13, wherein the food is sausage emulsion.
